(19) United States
(12) Patent Application Publication
(10) Pub. No.: US 2006/0222804 A1
(43) Pub. Date: Oct. 5, 2006

(54) Roll-up mat for roadways and the like

(76) Inventor: Murray Banting, Calgary (CA)

Correspondence Address: Adams Evans P.A., 2180 Two Wachovia Center, 301 S. Tryon Street, Charlotte, NC, 28282, US

(21) Appl. No.: 11/378,066

(22) Filed: Mar. 17, 2006

(30) Foreign Application Priority Data
Mar. 29, 2005 (CA) 2,502,746

(51) Int. Cl. B32B 3/10

(52) U.S. Cl. 428/54

(57) ABSTRACT

A method of covering a surface to protect the surface from vehicle traffic damage, and to facilitate vehicle travel over soft surfaces comprises providing a mat comprising a fabric sheet having right and left side edges, and a plurality of parallel sleeves spaced along a length of the sheet and extending across the sheet substantially perpendicular to the right and left side edges of the sheet, and a plurality of structural members, such as bamboo stalks, each structural member retained in one of the sleeves and extending substantially from the right side edge of the sheet to the left side edge of the sheet. The mat is rolled up into a cylinder and transported to a desired surface area where the mat is unrolled and positioned over the area to protect the surface from vehicles traffic, and to facilitate vehicle travel over the surface.

### TECHNICAL FIELD AND BACKGROUND OF THE INVENTION

This invention is in the field of temporary or portable roadways, and in particular such roadways that are suitable for use in sensitive environments and soft ground.

It is often required for construction, exploration, and like purposes to construct roadways through rough territory including soft ground. These roadways are often temporary and in the interests of preserving the environment, it is desired to have a roadway wherein equipment can enter an area to do a job as required and leave the area with as little damage to the ground surface as possible. Military and emergency measures organizations and the like also have occasion to move equipment quickly into areas where no roads are available. In soft ground vehicles get stuck and are unable to proceed until pulled by a tractor or the like, and even then they may not be able to proceed. The tractor further damages the ground, making ruts and so forth.

In other situations, while access is available, it is desirable to minimize damage from vehicles passing over a sensitive surface such as golf courses, parks, city boulevards, sidewalks, underground utility corridors, etc. Similarly it may be desired to provide an access path for recreational all terrain vehicles over bogs and streams with minimal disturbance. Further it is desirable in some situations to provide a path for vehicles over muddy areas in order to prevent mud from tracking onto city streets. Further still, pads over muddy areas around watering holes for livestock would improve access to the water.

Corduroy roads, wherein logs and so forth are laid lengthwise across the path of the road have been used in the past to cross soft areas of ground. Improvements to the well known corduroy road have are also known where the log elements are held together by flexible retainers passing through the elements, or by hinges attached to adjacent elements. Such improvements are disclosed for example in U.S. Pat. No. 5,282,692 to 10 McLeod, U.S. Pat. No. 6,652,184 to Knafelc et al., U.S. Pat. No. 4,804,570 to Bedics, U.S. Pat. No. 4,681,482 to Arciszewski et al., U.S. Pat. No. 6,575,660 to Davis et al., U.S. Pat. No. 3,912,408 to Domnick, U.S. Pat. No.3,595,140 to Lundin, and U.S. Pat. No. 305,328 to Peck.

### SUMMARY OF THE INVENTION

It is an object of the present invention to provide an apparatus for providing a roadway, platform, or the like over soft or sensitive ground that overcomes problems in the prior art.

The present invention provides, in a first embodiment, a mat apparatus for laying over a surface to protect the surface and facilitate vehicle travel over the surface. The mat apparatus comprises a fabric sheet having right and left side edges, and a plurality of sleeves spaced along a length of the sheet and extending across the sheet substantially perpendicular to the right and left side edges of the sheets, and a plurality of structural members. Each structural member is retained in one of the sleeves and extends substantially from the right side edge of the sheet to the left side edge of the sheet. The structural members and fabric sheet are selected to provide sufficient strength to support vehicles traveling over the fabric sheet when laid on the surface.

The present invention provides, in a second embodiment, a method of covering a surface to protect the surface from vehicle traffic damage, and to facilitate vehicle travel over soft surfaces. The method comprises providing a mat comprising a fabric sheet having right and left side edges, and a plurality of parallel sleeves spaced along a length of the sheet and extending across the sheet substantially perpendicular to the right and left side edges of the sheet, and a plurality of structural members, each structural member retained in one of the sleeves and extending substantially from the right side edge of the sheet to the left side edge of the sheet. The mat is rolled up into a substantially cylindrical configuration and transported to a desired surface area where the mat is unrolled and positioned over the desired surface area to protect the surface from vehicles driving over the mat, and to facilitate vehicle travel over the surface.

The mat apparatus spreads the weight of a vehicle traveling over the mat across an increased area of the surface compared to the conventional wheels, tracks, or the like on which the vehicle travels. The mat apparatus can be laid on the ground, including soft ground, as a roadway to facilitate travel by vehicles over the mat. The mat reduces damage caused to the ground surface by the vehicles.

The invention provides a mat that can be readily hauled to a site in quantities as required, and quickly assembled into a required size and configuration for use.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic perspective view of an embodiment of a mat for practicing the invention;

FIG. 2 is a top view of the embodiment of FIG. 1;

FIG. 3 is a perspective view of a vehicle traveling over a roadway made from the mats of FIG. 1;

FIG. 4 is a top view of a platform formed from a plurality of mats of FIG. 1;

FIG. 5 is an end view of the side-by-side attachment of the mats of FIG. 1;

FIG. 6 is a side view of the end-to-end attachment of the mats of FIG. 1;

FIG. 7 is a schematic side view showing the construction of the sleeves in the mat of FIG. 1;

FIG. 8 is a is a schematic side view showing the alternate construction of the sleeves in an alternate embodiment of a mat for practicing the invention;

FIGS. 9-11 are top views of an alternate embodiment of the mats with loops for attaching the front end of one mat to the rear end of an adjacent mat.

### DETAILED DESCRIPTION OF THE PREFERRED EMBODIMENTS

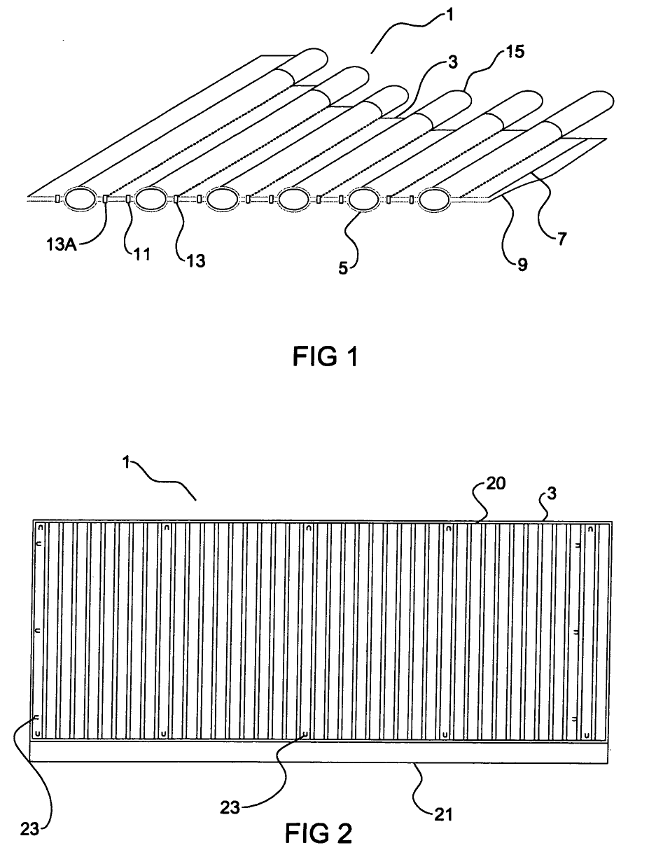

FIGS. 1 and 2 schematically illustrate a mat 1 for covering a surface to protect the surface from vehicle traffic damage, and to facilitate vehicle travel over soft surfaces. The mat 1 comprises a fabric sheet 3 having right and left side edges, and a plurality of parallel sleeves 5 spaced along a length of the sheet 3 and extending across the sheet 3 substantially perpendicular to the right and left side edges of the sheet.

Although it is contemplated that the sleeves 5 could provided in an alternate manner, in the illustrated embodiment the fabric sheet 3 comprises a top fabric layer 7 and a bottom fabric layer 9 having right and left side edges substantially aligned with corresponding right and left side edges of the top fabric layer 7. The bottom fabric layer 9 is connected to the top fabric layer 9 by stitches, staples, welds, dips, or the like to form the sleeves 5.

The bottom fabric layer 9 is connected to the top fabric layer 7 along substantially parallel front and rear seams 11,13 spaced apart by a sleeve width W, as illustrated in FIG. 7, and extending substantially from the right edge of the layers 7, 9 to the left edge of the layers 7, 9 to form each sleeve 5. As well the sleeves 5 are spaced apart from each other by spacing the front seam 11 of one sleeve a spacing distance D, as illustrated in FIG. 7, apart from the rear seam 13A of an adjacent sleeve 5. It is contemplated that a spacing distance in a range between the 75% of sleeve width and 150% of the sleeve width will provide satisfactory results.

A structural member 15 is retained in each sleeve 5 and extends substantially from the right side edge of the sheet 3 to the left side edge of the sheet 3. The illustrated structural member 15 is a cylindrical rod that could be made from fiberglass, plastic, wood, composite material, or metal however it has been found that a bamboo stalk provides a very satisfactory structural member 15, being strong, light, and economical to supply. The structural members 15 are conveniently retained in the sleeves 5 by a further retaining seam 20 closing the ends of the sleeves 5 as seen in FIG. 2.

The structural members 15 and fabric sheet 3 are selected to provide sufficient strength to support vehicles traveling over the fabric sheet when laid on the surface. The resulting mat 1 can be conveniently rolled into a cylindrical configuration and transported to a desired surface area where it can be unrolled and positioned over the desired surface area, and driven over by vehicles 17, as illustrated in FIG. 3.

The closely spaced structural members 15 spread the weight of the vehicle 17 both width-wise and somewhat length-wise along the fabric sheet 3 such that the fabric sheet is pushed downward and into the surface, however the weight per unit of area is greatly reduced. Thus instead of rutting due to the concentrated weight of the vehicle 17 on the bottom bearing area of the wheel 19 only, the surface is subjected to a much reduced force on each unit of area thereof, and is thereby protected. Similarly the vehicle 17 is supported on a soft surface, and does not bog down.

The fabric sheet 3 can be made from an impervious material such as polypropylene membrane, polyester membrane, inert polymer membrane, plastic membrane, or the like. If desired to allow water to seep up through the sheet 3, or to allow the surface under the mat 1 to receive air through the sheet 3, it can be made of geotextile or woven fabric, cloth, canvas, fine wire mesh, or the like. Typically it will be desirable that the material be non-toxic and have no effect on the environment.

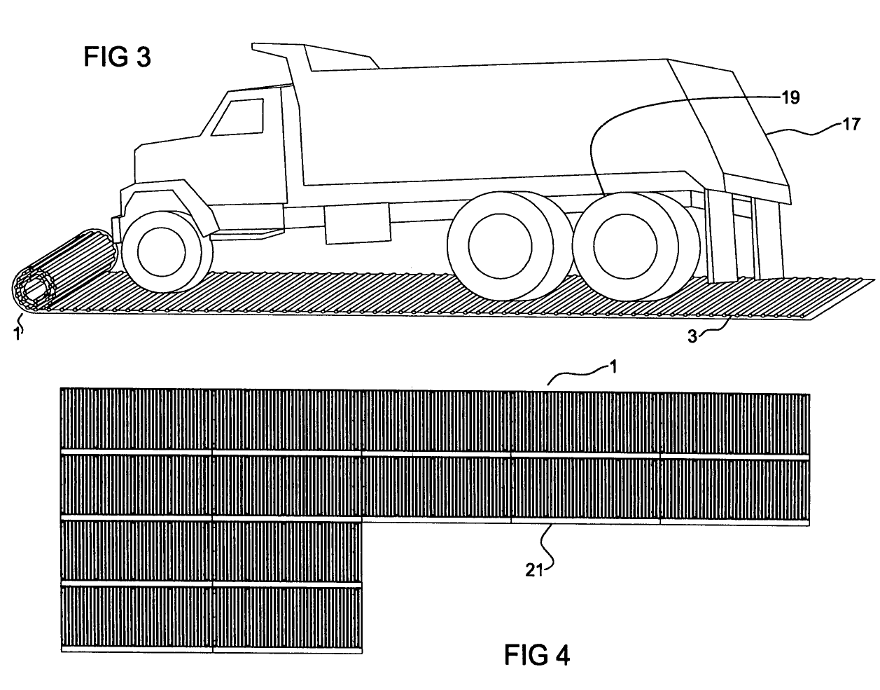

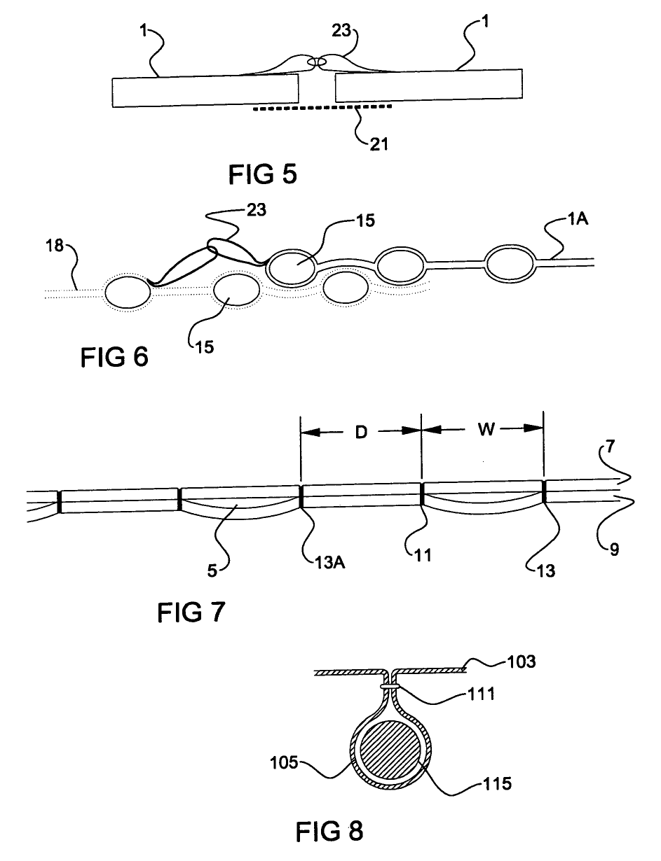

Although the mat 1 could be made in any size, conveniently a mat 1 would be provided in a width of about eight feet to cover the path of a typical vehicle 17, and a length of about 15 to 20 feet such that same could be readily carried by an individual. The mats 1 could then be attached to each other for covering a surface wider or longer than an individual mat 1. The mat 1 includes a flap 21 extending from the left side edge thereof, such that the right side edge of an adjacent mat overlaps the flap 21 when laid side by side as illustrated in FIG. 4. The right and left ends of the structural members 19 of the adjacent mats are then adjacent to each other, and the flap 21 restricts mud from squeezing up through the joint between the side-by-side mats 1 as illustrated in FIG. 5. Where the mats 1 are used to prevent tracking mud from a site onto local streets or the like the flap improves the efficacy of the mats 1 for that purpose.

Similarly the mats can be attached together at ends thereof as well, as illustrated in FIG. 4, for covering a surface longer than the mats. When attaching the mats 1A and IB end toend, the rear edge of one mat 1A overlaps the front end edge of the last mat IB such that one or two structural members 15 of mat 1A lie in the spaces between adjacent structural members 15 of the other mat IB, as illustrated in FIG. 6. This overlap keeps mud from squeezing up through the joint, and helps to prevent the mats from separating since when trying to move forward or rearward, the structural members of one mat will contact the structural members of the other mat and be inhibited from such movement. When a vehicle wheel or track is resting on the joint, the structural members 15 on one mat are pushed down and prevented from climbing over the structural members of the adjacent mat.

The mats 1 conveniently can comprise ties 23 attached to top surfaces thereof adjacent to the right and left side edges and front and rear end edges thereof. The mats 1 are attached to each other by connecting the ties 23. Typically the ties 23 comprise tethers adapted to be fastened together by hook and loop fasteners, knots, snap hooks, or like known fasteners.

FIG. 8 schematically illustrates an alternate manner of making a sleeve 105 in a fabric sheet 103 by folding the single layered sheet 103 to form the sleeve 105, and running a seam 111 along the fold as illustrated. A structural element 115 can then be inserted into the sleeve 105.

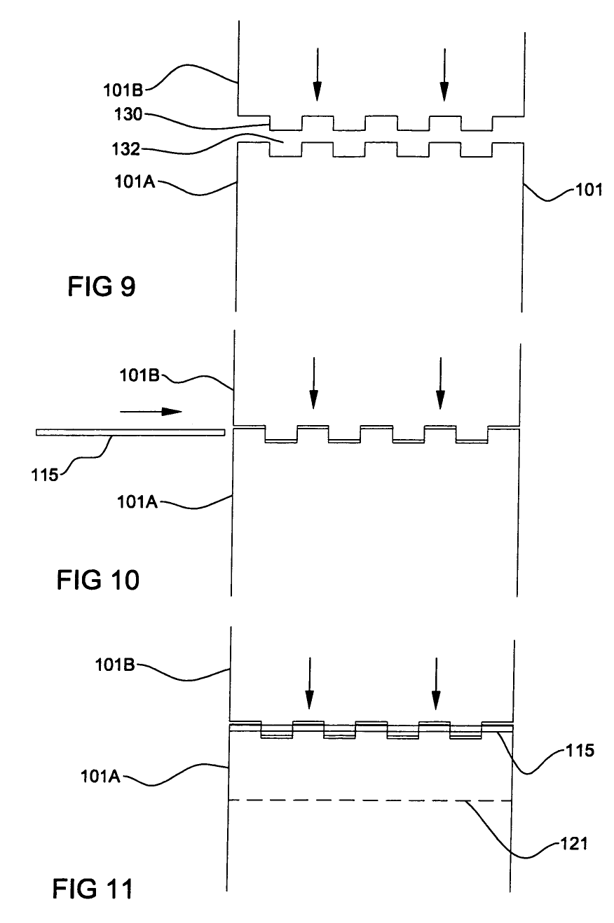

FIGS. 9-11 schematically illustrate and alternate embodiment of the mat 101 wherein the ends include loops 130 extending from front and rear ends 101 A, 101B of the mats 101. The loops 130 are offset on front ends compared to rear ends such that the mats can be aligned as illustrated in FIG. 9, and the loops of one end moved into corresponding gaps 132 in the other end as shown in FIG. 10. A structural member 115 can then be inserted to join the front end 101A of one mat 101 to the rear end 101B of an adjacent mat 101, as illustrated in FIG. 11. A flap 121, similar to the flap 21 described above as extending from the side of the mat, could be added to the front or rear ends 101 A, 101B of the mats so as to extend under the joint and prevent mud from squeezing up through the joint, as illustrated by the phantom line in FIG. 11.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. A mat apparatus for laying over a surface to protect the surface and facilitate vehicle travel over the surface, the apparatus comprising:
a fabric sheet having right and left side edges, and a plurality of sleeves spaced along a length of the sheet and extending across the sheet substantially perpendicular to the right and left side edges of the sheets;
a plurality of structural members, each structural member retained in one of the sleeves and extending substantially from the right side edge of the sheet to the left side edge of the sheet;
wherein the structural members and fabric sheet are selected to provide sufficient strength to support vehicles traveling over the fabric sheet when laid on the surface.

2. The apparatus of claim 1 wherein the fabric sheet comprises a top fabric layer and a bottom fabric layer having right and left side edges substantially aligned with corresponding right and left side edges of the top fabric layer, wherein the bottom fabric layer is connected to the top fabric layer to form the plurality of sleeves.

3. The apparatus of claim 2 wherein the bottom fabric layer is connected to the top fabric layer long substantially parallel front and rear seams spaced apart by a sleeve width and extending substantially from the right edge of the layers to the left edge of the layers to form each sleeve, and wherein the front seam of one sleeve is spaced from the rear seam of an adjacent sleeve.

4. The apparatus of claim 2 wherein the front seam of one sleeve is spaced from the rear seam of an adjacent sleeve by a spacing distance in a range between 75% of the sleeve width and 150% of the sleeve width.

5. The apparatus of claim 2 wherein the bottom fabric layer is connected to the top fabric layer by one of stitches, staples, welds, and clips.

6. The apparatus of claim 1 wherein the structural members comprise at least one bamboo stalk.

7. The apparatus of claim 1 wherein the structural members comprise one of fiberglass rods, plastic rods, wooden rods, composite rods, and metal rods.

8. The apparatus of claim 1 wherein the fabric layers comprise one of polypropylene membrane, polyester membrane, inert polymer membrane, plastic membrane, wire mesh, cloth, and canvas.

9. The apparatus of claim 1 further comprising a flap extending from a side edge of the fabric sheet.

10. The apparatus of claim 1 further comprising ties attached to top surfaces thereof adjacent to the right and left side edges thereof, and adjacent to front and rear end edges thereof.

11. The apparatus of claim 10 wherein the ties comprise tethers adapted to be fastened to tethers of an adjacent apparatus by one of hook and loop fasteners, knots, and snap hooks.

12. The apparatus of claim 1 further comprising loops extending from front and rear ends of the sheet, and wherein the loops are offset on front ends compared to rear ends such that adjacent sheets can be aligned and the loops of one end moved into corresponding gaps in the other end, and such that a structural member can then be inserted through the loops to join the front end of one sheet to the rear end of an adjacent sheet.

13. The apparatus of claim 12 further comprising a flap extending from an end edge of the fabric sheet.

14. A method of covering a surface to protect the surface from vehicle traffic damage, and to facilitate vehicle travel over soft surfaces, the method comprising:
providing a mat comprising:
a fabric sheet having right and left side edges, and a plurality of parallel sleeves spaced along a length of the sheet and extending across the sheet substantially perpendicular to the right and left side edges of the sheet; and
a plurality of structural members, each structural member retained in one of the sleeves and extending substantially from the right side edge of the sheet to the left side edge of the sheet;
rolling the mat up into a substantially cylindrical configuration and transporting the mat to a desired surface area;
unrolling the mat and positioning the mat over the desired surface area to protect the surface from vehicles driving over the mat, and to facilitate vehicle travel over the surface.

15. The method of claim 14 wherein the fabric sheet comprises a top fabric layer and a bottom fabric layer having right and left side edges substantially aligned with corresponding right and left side edges of the top fabric layer, wherein the bottom fabric layer is connected to the top fabric layer to form the plurality of sleeves.

16. The method of claim 15 wherein the bottom fabric layer is connected to the top fabric layer along substantially parallel front and rear seams spaced apart by a sleeve width and extending substantially from the right edge of the layers to the left edge of the layers to form each sleeve, and wherein the front seam of one sleeve is spaced from the rear seam of an adjacent sleeve.

17. The method of claim 16 wherein the front seam of one sleeve is spaced from the rear seam of an adjacent sleeve by a spacing distance in a range between 75% of the sleeve width and 150% of the sleeve width.

18. The method of claim 15 wherein the bottom fabric layer is connected to the top fabric layer by at least one of stitches, staples, welds, and clips.

19. The method of claim 14 wherein the structural members comprise at least one bamboo stalk.

20. The method of claim 14 wherein the structural members comprise one of fiberglass rods, plastic rods, wooden rods, composite rods, and metal rods.

21. The method of claim 14 wherein the fabric sheet comprises at least one of polypropylene membrane, polyester membrane, inert polymer membrane, plasticmembrane, wire mesh, cloth, and canvas.

22. The method of claim 14 for covering a surface wider than the mat, the method further comprising providing first and second mats, and attaching the right side edge of the first mat to the left side edge of the second mat.

23. The method of claim 22 wherein the second mat comprises a flap extending from the left side edge thereof, and wherein the right side edge of the first mat overlaps the flap such that right and left ends of the structural members of the first and second mats are adjacent to each other.

24. The method of claim 22 wherein the mats comprise ties attached to top surfaces thereof adjacent to the right and left side edges thereof, and wherein the mats are attached to each other by connecting the ties.

25. The method of claim 22 for covering a surface longer than the mats, the method further comprising providing third and forth mats, and attaching a rear end edge of the third mat to a front end edge of the first mat, and attaching a rear end edge of the fourth mat to a front end edge of the second mat, and attaching the rightside edge of the third mat to the left side edge of the fourth mat.

26. The method of claim 25 wherein the rear end edge of the third mat overlaps the front end edge of the first mat such that at least one structural member of the thirdmat lies in a spacing between two adjacent structural members of the first mat.

27. The method of claim 25 wherein the mats comprise ties attached to top surfaces thereof adjacent to the front and rear end edges thereof, and wherein the mats are attached to each other by connecting the ties.
